(19) United States
(12) Patent Application Publication
(10) Pub. No.: US 2014/0190319 A1
(43) Pub. Date: Jul. 10, 2014

(54) Adjustable wrench

(71) Applicant: Yu Tsung Chen, Taichung (TW)

(72) Inventor: Yu Tsung Chen, Taichung (TW)

(21) Appl. No.: 13/738,951

(22) Filed: Jan. 10, 2013

(51) Int. Cl. B25B 13/16

(52) U.S. Cl. CPC B25B 13/16
USPC 81/170

(57) ABSTRACT

An adjustable wrench is provided with a handle including a head; a fixed jaw formed with the head; a slot through the head; a cavity in the head and communicating with the slot, a shaft channel through the cavity; a forward recess in the fixed jaw; a rearward well in the head; a head cover including an opening aligned with the cavity, a forward protrusion fitted in the recess, and a rearward protuberance fitted in the well; a joining assembly for joining the head and the head cover; a moveable jaw including an adjustable shank received in the slot, and serrated teeth along the adjustable shank; a thread screw adjustment driver in both the cavity and the opening; and a assembly shaft in the shaft channel and through the thread screw adjustment driver. The thread screw adjustment driver is threadedly secured to the serrated teeth.

### BACKGROUND OF THE INVENTION

1. Field of the Invention

The invention relates to adjustable wrenches and more particularly to such an adjustable wrench with improved characteristics.

2. Description of Related Art

There is a conventional type of adjustable wrench for permitting quick slip adjustment. The adjustable wrench comprises a handle, a wrench body and a fixed jaw; a floating jaw having serrated teeth along an adjustable shank; and a singly-grooved, interrupted thread screw adjust driver mounted upon an assembly shaft. The thread screw adjust driver includes helical threads that are interrupted by at least one groove that is continuous along an entire length of the thread screw adjust driver. The groove is parallel to the assembly shaft. The assembly shaft is a key-way type shaft. The wrench body includes a slot adapted to receive the adjustable shank of the floating jaw, the interrupted thread screw adjust driver being adjustable to engage the serrated teeth of the floating jaw and adjustable to not engage the serrated teeth of the floating jaw.

Notwithstanding the prior art, the invention is neither taught nor rendered obvious thereby.

### SUMMARY OF THE INVENTION

It is therefore one object of the invention to provide a adjustable wrench comprising a handle comprising a head; a fixed jaw integrally formed with the head; a slot formed through the head; a cavity formed in the head and communicating with the slot, a shaft channel formed through the cavity; a forward recess formed in the fixed jaw; a rearward well formed in the head; a head cover comprising an opening aligned with the cavity, a forward protrusion fitted in the forward recess, and a rearward protuberance fitted in the rearward well; a joining assembly for joining the head and the head cover; a moveable jaw comprising an adjustable shank received in the slot, and serrated teeth formed along the adjustable shank; a thread screw adjustment driver disposed in both the cavity and the opening; and an assembly shaft rotatably disposed in the shaft channel and formed through the thread screw adjustment driver; wherein the thread screw adjustment driver is threadedly secured to the serrated teeth; and wherein the head cover is complimentary to the head.

The above and other objects, features and advantages of the invention will become apparent from the following detailed description taken with the accompanying drawings.

### BRIEF DESCRIPTION OF THE DRAWINGS

FIG. 1 is a side elevation of jaws and adjacent handle of an adjustable wrench according to the invention a first preferred embodiment of the invention, the jaws being closed;

FIG. 2 is a view similar to FIG. 1 showing the jaws being open;

FIG. 3 is an exploded view of FIG. 1 with both the thread screw adjustment driver and the assembly shaft removed;

FIG. 4 is a perspective view of the assembled components (i.e., head and adjacent handle portion) shown in FIG. 3;

FIG. 5 is an exploded view of the head and adjacent handle portion of an adjustable wrench according to the invention a second preferred embodiment of the invention;

FIG. 6 is an exploded view of the head and adjacent handle portion of an adjustable wrench according to the invention a third preferred embodiment of the invention; and

FIG. 7 is an exploded view of the head and adjacent handle portion of an adjustable wrench according to the invention a fourth preferred embodiment of the invention.

### DETAILED DESCRIPTION OF THE INVENTION

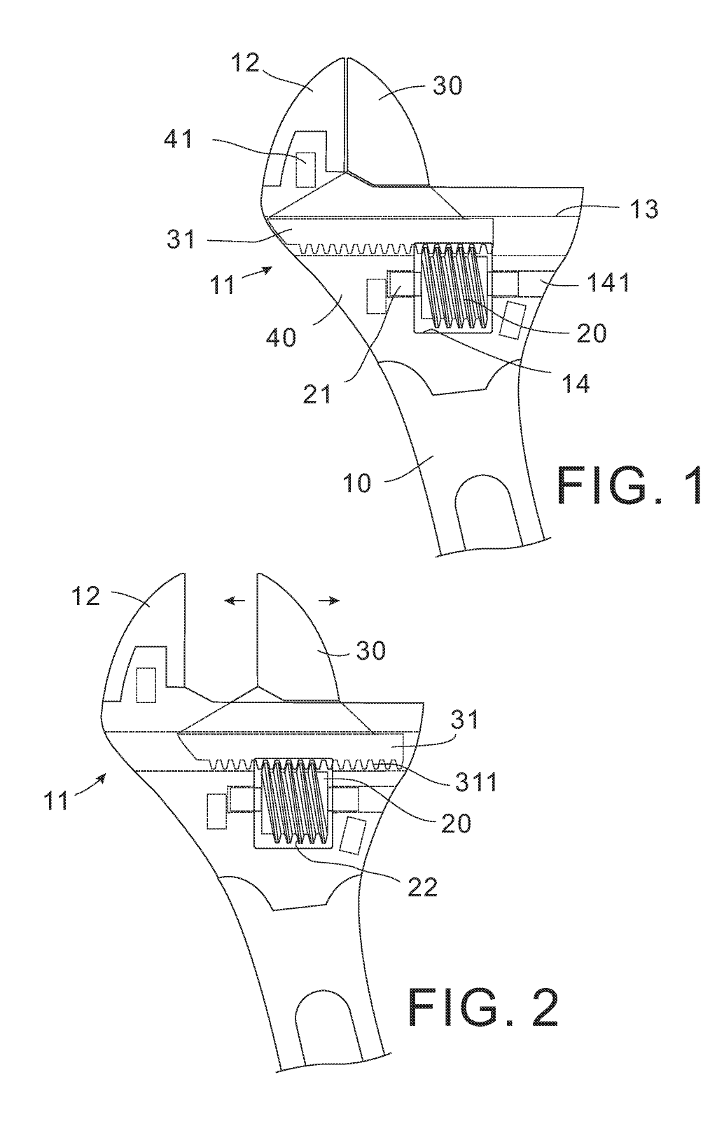

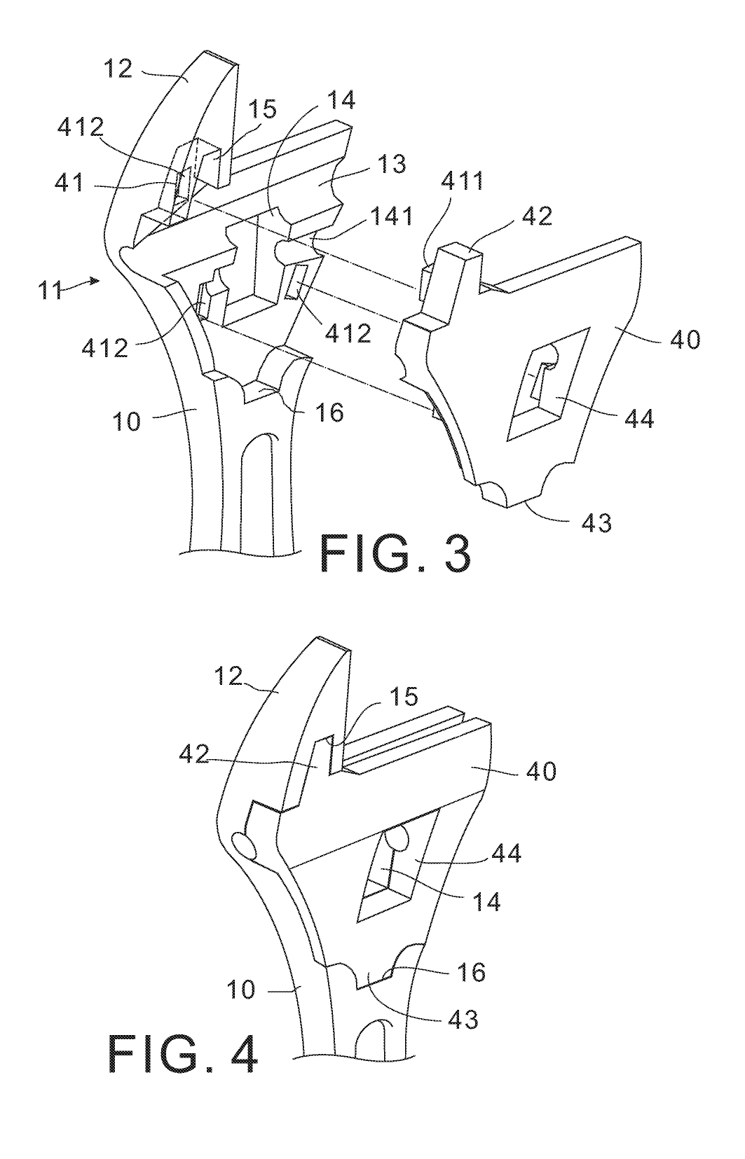

Referring to FIGS. 1 to 4, an adjustable wrench in accordance with the invention comprises the following components as discussed in detail below.

A handle 10 comprises a projecting head 11 including an integral fixed jaw 12, a slot 13 through the head 11 and being perpendicular to a straight gripping face of the fixed jaw 12, a rectangular cavity 14 perpendicular to the slot 13 and communicating therewith, a shaft channel 141 through the cavity 14 and being perpendicular therewith, the channel 141 having an open end, a recess 15 on a forward portion of the slot 13 (i.e., in the fixed jaw 12) opposite the rearward cavity 14, and a rear well 16 in close proximity to the handle 10.

A complimentary head cover 40 comprises a forward protrusion 42 adapted to snugly fit in the recess 15, a joining assembly 41 in the recess 15, the joining assembly 41 including three pairs of a recessed portion 412 having a rectangular cross-section and a projection 411 having a rectangular cross-section and projecting out of an inner surface of the head cover 40, the projections 411 being adapted to snugly fit in the recessed portions 412, a rear protuberance 43 adapted to fit in the well 16, and a rectangular opening 44 aligned with the cavity 14.

A moveable jaw 30 comprises an adjustable shank 31 including serrated teeth 311 along a rear edge. The adjustable shank 31 is received in the slot 13. A thread screw adjustment driver 20 comprises five helical threads (not numbered). An assembly shaft 21 is rotatably disposed in the shaft channel 141 and formed through the thread screw adjustment driver 20. The thread screw adjustment driver 20 is disposed in both the cavity 14 and the opening 44 and has its threads threadedly secured to the teeth 311. Further, the assembly shaft 21 is exposed. Furthermore, the head cover 40 is complimentarily secured to the head 11.

It is envisaged by the invention that a rotation of the thread screw adjustment driver 20 can move the moveable jaw 30 to either increase or decrease a distance between the fixed jaw 12 and the moveable jaw 30.

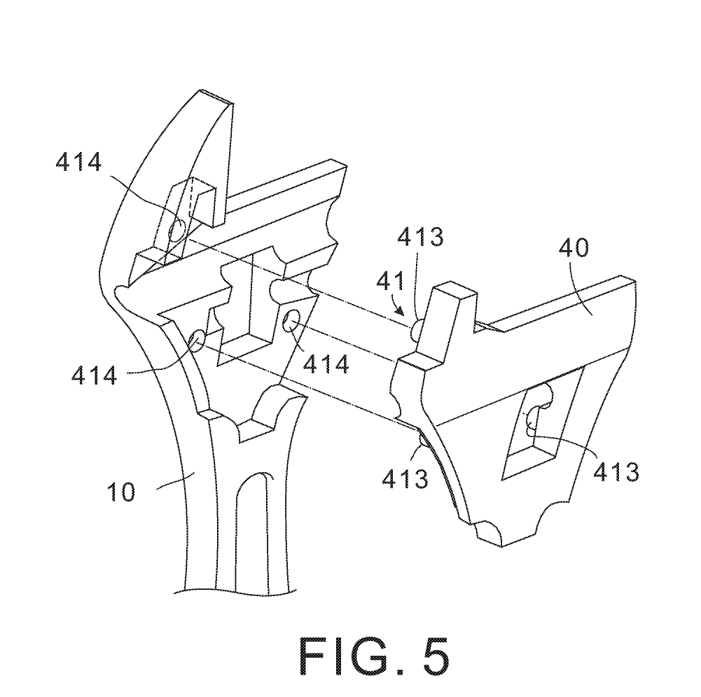

Referring to FIG. 5, an adjustable wrench in accordance with a second preferred embodiment of the invention is shown. The characteristics of the second preferred embodiment are substantially the same as that of the first preferred embodiment except the following: Each of recessed portions 414 has a circular cross-section and each of projections 413 has a circular cross-section so that the projections 413 are adapted to snugly fit in the recessed portions 414.

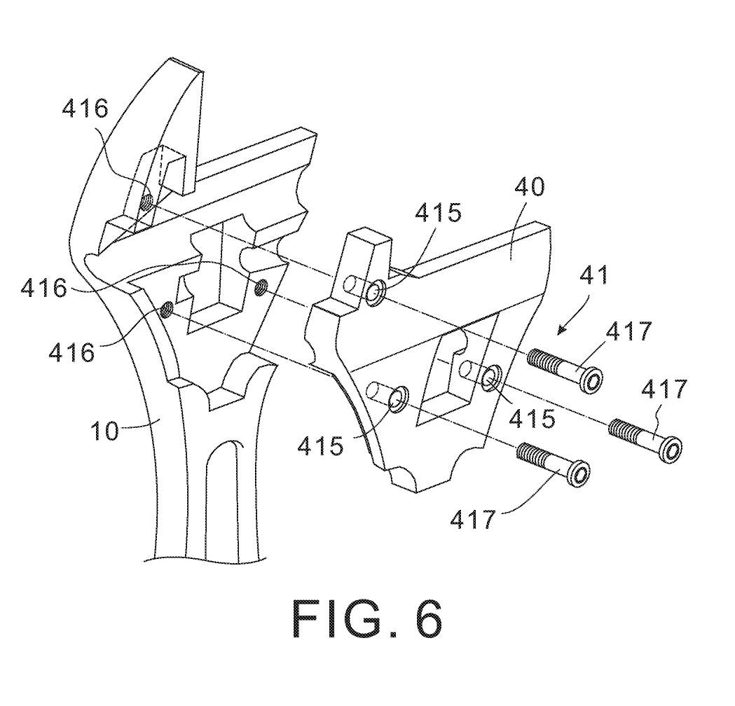

Referring to FIG. 6, an adjustable wrench in accordance with a third preferred embodiment of the invention is shown. The characteristics of the third preferred embodiment are substantially the same as that of the second preferred embodiment except the following: Each of recessed portions 416 is internally threaded. Each of through holes 415 are formed through the head cover 40. A plurality of threaded fasteners 417 are driven through the through holes 415 into the recessed portions 416 to fasten the head cover 40 and the head 10 together.

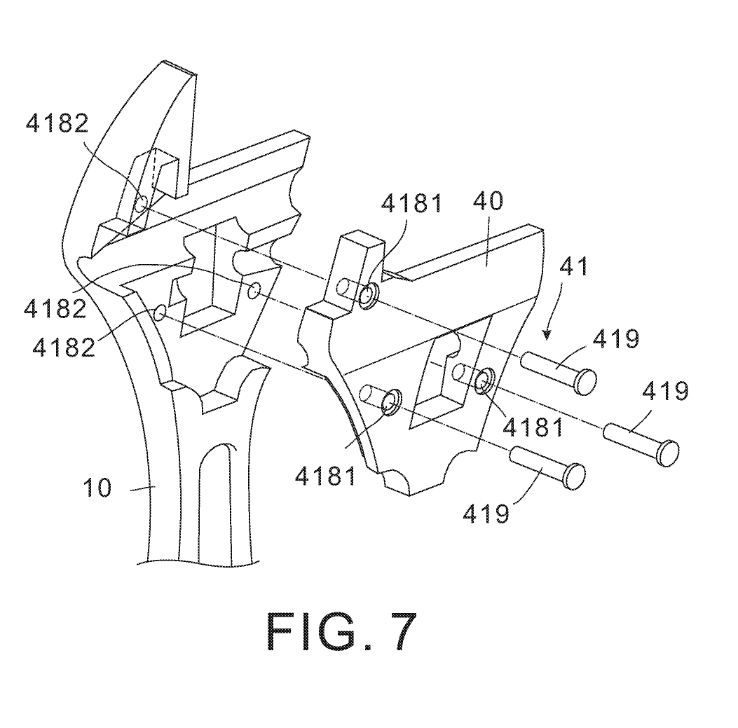

Referring to FIG. 7, an adjustable wrench in accordance with a fourth preferred embodiment of the invention is shown. The characteristics of the fourth preferred embodiment are substantially the same as that of the third preferred embodiment except the following: Each of recessed portions 4182 is not internally threaded. A plurality of rivets 419 are driven through three through holes 4181 into the recessed portions 4182. Further, the rivets 419 are hammered to fasten the head cover 40 and the head 10 together.

While the invention has been described in terms of preferred embodiments, those skilled in the art will recognize that the invention can be practiced with modifications within the spirit and scope of the appended claims.

What is claimed is:

1. An adjustable wrench comprising:
a handle comprising a head;
a fixed jaw integrally formed with the head;
a slot formed through the head;
a cavity formed in the head and communicating with the slot,
a shaft channel formed through the cavity;
a forward recess formed in the fixed jaw;
a rearward well formed in the head;
a head cover comprising an opening aligned with the cavity, a forward protrusion fitted in the forward recess, and a rearward protuberance fitted in the rearward well;
a joining assembly for joining the head and the head cover;
a moveable jaw comprising an adjustable shank received in the slot, and serrated teeth formed along the adjustable shank;
a thread screw adjustment driver disposed in both the cavity and the opening; and
an assembly shaft rotatably disposed in the shaft channel and formed through the thread screw adjustment driver;
wherein the thread screw adjustment driver is threadedly secured to the serrated teeth; and
wherein the head cover is complimentary to the head.
